(19) United States
(12) Patent Application Publication
(10) Pub. No.: US 2017/0344644 A1
(43) Pub. Date: Nov. 30, 2017

(54) RANKING NEWS FEED ITEMS USING PERSONALIZED ON-LINE ESTIMATES OF PROBABILITY OF ENGAGEMENT

(71) Applicant: LinkedIn Corporation, Mountain View, CA (US)

(72) Inventors: Nikita Igorevych Lytkin, Sunnyvale, CA (US); Liang Tang, Sunnyvale, CA (US); Guy Lebanon, Menlo Park, CA (US)

(21) Appl. No.: 15/163,326

(22) Filed: May 24, 2016

(51) Int. Cl. G06F 17/30; G06N 7/00; G06N 99/00

(52) U.S. Cl. CPC G06F 17/30867; G06N 99/005; G06F 17/30377; G06F 17/3053; G06N 7/005

(57) ABSTRACT

An on-line social network system includes a ranker to processes an inventory of news feed updates for a member and select more relevant updates for presentation to the member. The ranker is trained using training data that includes personalized engagement probability for an update. The personalized engagement probability values are calculated in real time and for a particular update with respect to member features that appear in member profiles maintained by the on-line social network system.

### TECHNICAL FIELD

This application relates to the technical fields of software and/or hardware technology and, in one example embodiment, to system and method to estimate personalized engagement probability for an update in an on-line social network.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

A member of on-line social network may be permitted to share information with other members by posting an update that would appear on respective news feed pages of the other members. An update may be an original message, a link to an on-line publication, a re-share of a post by another member, etc. Members that are presented with such an update on their news feed page may choose to indicate that they like the post, may be permitted to contribute a comment, etc.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to estimate personalized engagement probability for an update in an on-line social network may be implemented;

FIG. 2 is block diagram of a system to estimate personalized engagement probability for an update in an on-line social network, in accordance with one example embodiment;

FIG. 3 is a flow chart of a method to estimate personalized engagementprobability for an update in an on-line social network, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to estimate personalized engagement probability for an update in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile of a member may also include information about the member's current and past employment, such as company identifications, professional titles held by the associated member at the respective companies, as well as the member's dates of employment at those companies. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. The on-line social network system, in some embodiments, also permits a one-sided connection, where a member is permitted to follow another member or another entity, such as a company, a university, etc. When a member follows another member or entity, that member's profile is associated with a link indicative of a one-sided connection, where, e.g., the member receives updates regarding the other member or the entity that the member follows.

An update, for the purposes of this description, is an information item for presentation to one or more members represented by respective member profiles in the on-line social network system. The updates may be presented as part of the member's so-called news feed. A news feed may be provided to a member on a dedicated web page, e.g., on a home page of the member in the on-line social network. A news feed page is generated for each member by a news feed system provided with the on-line social network system and includes items that has been determined as being potentially of interest to that member. Examples of items in the news feed generated for a member are posts and news with respect to the connections of that member and the entities that the member is following, as well as job postings that have been determined as relevant to the member. As there may be a rather large inventory of updates available for inclusion into a member's news feed, the news feed system is configured to select a subset of all available updates for inclusion into the news feed. Such selection maybe based on various selection criteria, such as, e.g., the degree of relevance of an update item with respect to the member, the degree of connection between the member and the source of the update, etc.

Updates that are being considered for insertion into a member's news feed in the on-line social network may originate from various sources, such as, e.g., posts by members who are connections of the focus member (either mutual connections or entities that is being followed by the focus member), news with respect to members who are connections of the focus member, news articles, job postings, etc. Updates from a source is first ranked based on a predetermined criteria, and then a subset of highest-ranked update items is provided to a so-called second pass ranker to be ranked together with the updates from other sources. For example, from all job postings available in the on-line social network system, only those sufficiently relevant to the focus member are provided to the second pass ranker. From all news articles available in the on-line social network system, only a subset is provided to the second pass ranker. The second pass ranker, which may be part of the news feed system and may employ a statistical model, processes the inventory of updates received from multiple sources for the focus member to select a final set of updates, which is then included in the news feed web page that is being generated for the focus member. The second pass ranker may rank the items in the inventory of updates utilizing, e.g., a statistical model, such as logistic regression, based on a set of attributes describing each item and the focus member. Such attributes may include the type of the item (e.g., job recommendation, connection recommendation, news article share, etc.), focus member's past counts of interactions with items of this type, profile attributes of the focus member (e.g., skills, industry, education, etc.), as well as profile attributes of the member whose activity resulted in generation of this item (e.g., member article share), etc. The second pass ranker is trained on demand or on a periodic basis using various types of training data historical data reflecting members' interactions with updates, such as, e.g., so-called item popularity.

In news feeds (also referred to as merely feeds), item popularity is a measure of how many users engage with a feed item (also referred to as an update for the purposes of this description) in the past. If a feed item has more clicks and viral actions (comments, likes or shares) in the last a few days, then this feed item is more popular than an item that has fewer clicks and viral actions. Therefore, the number of clicks and viral actions for each feed item can be used to measure respective popularity of feed items in the past and predict their click probabilities in future. This is called global item popularity. The global item popularity is a feature that is used in many recommender systems, as popularity indicates the quality of the recommended item that is calculated based on actual user engagement signals, so it is often more accurate and objective than any prediction. The item popularity is represented by the number of received clicks, likes, shares, comments and other actions of each feed item. In feed relevance modeling, the second pass ranker uses the global item popularity as one of its input signals.

In order to determine the global item popularity for an update the news feed system may track the number of actions by members with respect to the update and, in some embodiments, also the number of update impressions (irrespective of member attributes) and use these tracked events as features log(# impressions on an update) or the number of clicks by members on the update) as training data for the second pass ranker.

As it is possible that different viewers have different interests, an update may different popularity when considered with respect to different groups of members. For instance, if a member has a skill “Spark,” the article about “DataBricks” could be very interesting to him (or her). On the other hand, if a member is an artist and does not work with data processing engines, the article about “DataBricks” is not relevant to him (or her).

In one example embodiment, the second pass ranker uses the training data that includes so-called personalized engagement probability for an update. The term personalized is used to express that the probability values (coefficients) are calculated for a particular update with respect to member features stored in a bank of features associated with the on-line social network system. These personalized engagement probability values for an update are calculated for a particular update in real time, especially for the teed items that usually have very short life cycle, and are used as input for training the second pass ranker. In one embodiment, the personalized engagement probability for an update, also referred to as the personalized popularity score may be determined as described below.

Let f₁, f₁, . . . , fₙ be the member features stored in a member features dictionary in the on-line social network system. In one embodiment, f₁, f₂, . . . , fₙ are the skills of a member in the associated member profile in the on-line social network system. The skills are words and phrases stored electronically in a skills dictionary. A skill from the skills dictionary included in a member profile represents a professional or some other skill of a member associated with that member profile. For each member feature fᵢ, i=1, . . . , n from the member features dictionary and for each update tᵢ, j−1, . . . n, a news feed system estimates the click probability Pr(click=1|fᵢ, tⱼ) as the probability of a click on the update tⱼ by a member whose profile includes the feature fᵢ. Since every member profile in the on-line social network system has its own set of member features, the overall popularity score is personalized for a specific update with respect to a particular feature. The training of the second pass ranker comprises taking every value Pr(click=1|fᵢ, tⱼ) and learning a resulting coefficient for every member feature. Therefore, for a particular update, its own coefficient is calculated for every member feature.

Examples of types of actions that a user may perform with respect to a teed item (an update) are interactions and viral actions. Interactions include, e.g.: CLICK SHARE, COMMENT, LIKE, CONNECT, FOLLOW, VIEW, PLAY, MESSAGE, and EXPAND. The viral actions include, e.g.: SHARE, COMMENT and LIKE. In the embodiments where different types of interactions are treated as representing different degrees of user engagement with an update, the news feed system may assign different weights to coefficients generated with respect to different types of action. For example, given two types of interaction mentioned above, and supposing that the viral action is considered to represent a greater degree of engagement than an interaction, the popularity score for the update tⱼ with respect to the member feature fᵢ is calculated using weights w1 and w2, where w2 is a greater value than w1. The popularity score for the update tⱼ with respect to the member feature fᵢ is calculated as the sum of the weighted popularity score for the update tⱼ with respect to the member feature fᵢ for interactions and the weighted popularity score for the update tⱼ with respect to the member feature fᵢ for viral actions, as shown below.

The popularity score=w1·Pr(interaction=1|fᵢ, tⱼ)=w2·Pr(viral action=1|fᵢ,tⱼ)

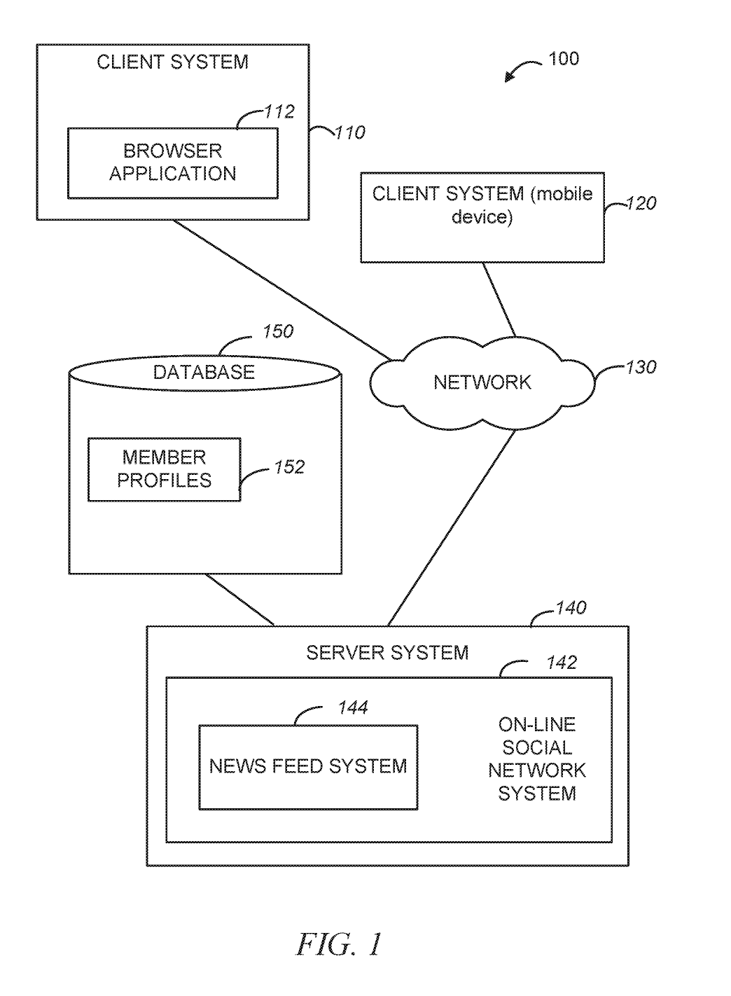

Example method and system to estimate personalized engagement probability for an update in an on-line social network may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

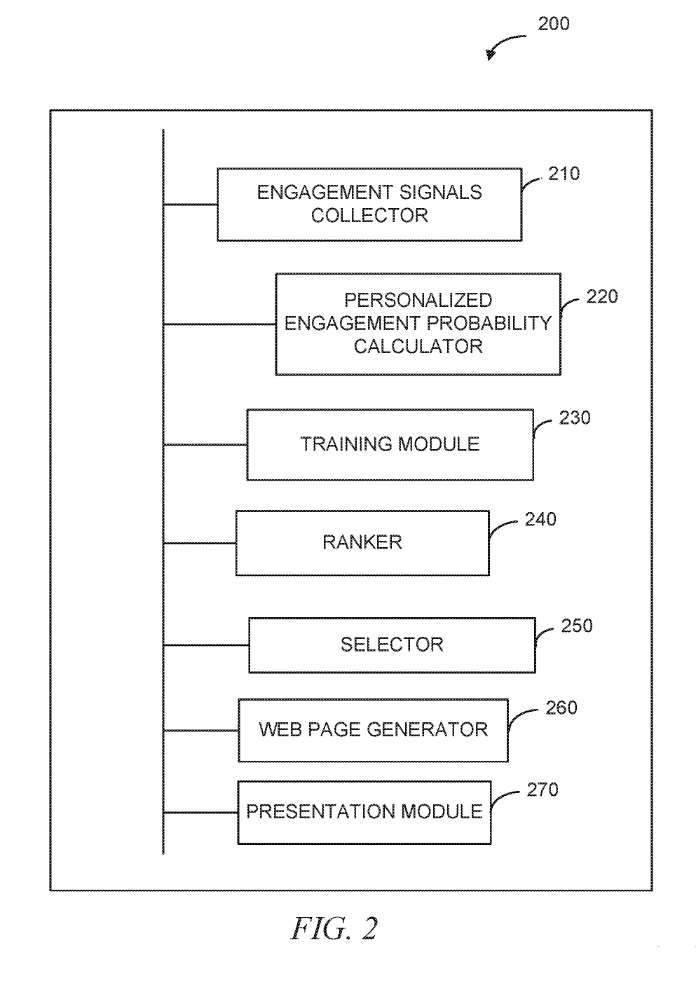

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a news feed system 144 that may be utilized beneficially to processes an inventory of news feed updates for a member and select more relevant updates for presentation to the member. The news feed system 144 includes a second pass ranker that is trained using training data that includes personalized engagement probability for an update, and a system to generate said personalized engagement probability using the methodologies described above. The personalized engagement probability values are calculated in real time and for a particular update with respect to member features that appear in the member profiles 152 maintained by the on-line social network system 142 in the database 150. An example news feed system 144 is illustrated in FIG. 2.

FIG. 2. is a block diagram of a system 200 to estimate personalized engagement probability for an update in an on-line social network, in accordance with one example embodiment. As shown in FIG. 2, the system 200 includes an engagement signals collector 210, a personalized engagement probability calculator 220, a training module 230, a ranker 240, and a selector 250.

The engagement signals collector 210 is configured to collect engagement signals in real time with respect to a focus update in the on-line social network system 142 of FIG. 1. An engagement signal represents a positive engagement with the update or an absence of engagement with the update by a member from the focus members. The focus members are those members in the on-line social network system 142 to whom the update has been presented. The focus members are represented by respective member profiles that each includes one or more features from a set of features maintained in a bank of features in the on-line social network system 142. In some embodiments, as described above, a bank of features is a dictionary of skills. The focus update is an information item for presentation to one or more members represented by respective member profiles in the on-line social network system 142, such as, e.g., a job posting or a news article.

The personalized engagement probability calculator 220 is configured to calculate, in real time, for the focus update and the set of features, respective probabilities of positive engagement with the focus update by a member represented by a profile that includes a feature from the set of features, based on the collected engagement signals. Pr(click=1|fᵢ, tⱼ) is the probability of a click on the update tⱼ by a member whose profile includes the feature fᵢ. The training module 230 is configured to include the calculated respective probabilities as training data for training the ranker 240. In some embodiments, training of the ranker 240 is done on-line, as training data comes. In other embodiments, training of the ranker 240 is performed offline (e.g., once per day) using the training data accumulated to date.

The personalized engagement probability calculator 220, in some embodiments, is configured to generate a probability of positive engagement with an update tⱼ by a member represented by a profile that includes features f₁, f₂, . . . , fₙ Pr(Click|f₁, f₂, . . . , fₙ, tⱼ). In this case, instead of estimating probabilities Pr(click=1|fᵢtⱼ), i=1, . . . , n, of engagement with update tⱼ for each member feature independently, a multivariate model such as, e.g., Naive Bayes or logistic regression can be trained and continuously updated in real time thereby providing a more accurate estimate of the probability of interaction. Such multivariate model is used to estimate the probability Pr(click=1|f₁, f₂, . . . , fₙ, tⱼ) of interaction as a function of member features fᵢ, i=1, . . . , n, jointly. The estimate of Pr(click=1|f₁, f₂, . . . , fₙ, tⱼ) or a function thereof (e.g., logit) can then be used as an additional signal in the second pass ranking model, and be included as training data for training the ranker 240.

The ranker 240 (that, in some embodiments correspond to the final pass ranker described above) is configured to generate a rank for each item in an inventory of updates based on features associated with a member profile and the item in the on-line social network system 142.

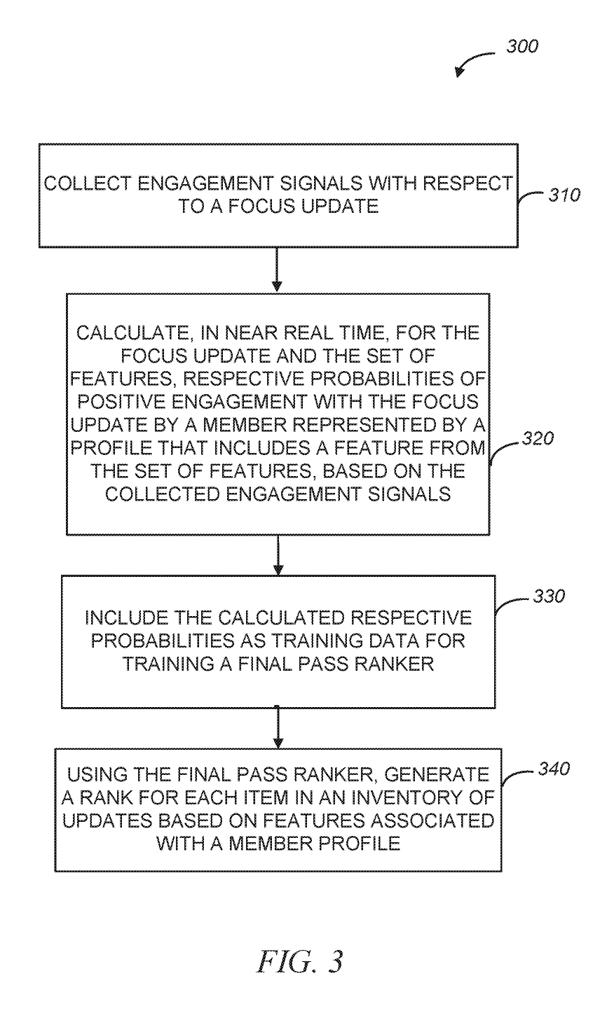

Also shown in FIG. 2 are a web page generator 260 and a presentation module 270. The web page generator 260 is configured to construct a news feed web page that includes the one or more items from the inventory. The presentation module 270 is configured to cause presentation of the news teed web page on a display device of a member, for whom the news feed page has been generated. Some operations performed by the system 200 may be described with reference to FIG. 3.

FIG. 3 is a flow chart of a method 300 to estimate personalized engagement probability for an update in an on-line social network for a member, according to one example embodiment. The method 300 may be performed by processing logic that may comprise hardware (e,g., dedicated logic, programmable logic, microcode, etc), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the engagement signals collector 210 of FIG. 2 collects engagement signals with respect to a focus update in the on-line social network system 142 of FIG. 1. The personalized engagement probability calculator 220 of FIG. 2 calculates, in real time, at operation 320, for the focus update and the set of features, respective probabilities of positive engagement with the focus update by a member represented by a profile that includes a feature from the set of features, based on the collected engagement signals, As described above, Pr(click=1|fᵢ, tⱼ) is the probability of a click on the update tⱼ by a member whose profile includes the feature fᵢ. At operation 330, the training module 230 of FIG. 2 includes the calculated respective probabilities as training data for training the ranker 240. Ranker 240 can be trained online as the data comes in, or offline via a batch process with certain periodicity (e.g., once per day). The ranker 240 of FIG. 2 generates a rank for each item in an inventory of updates based on features associated with a member profile in the on-line social network system 142, at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be preformed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

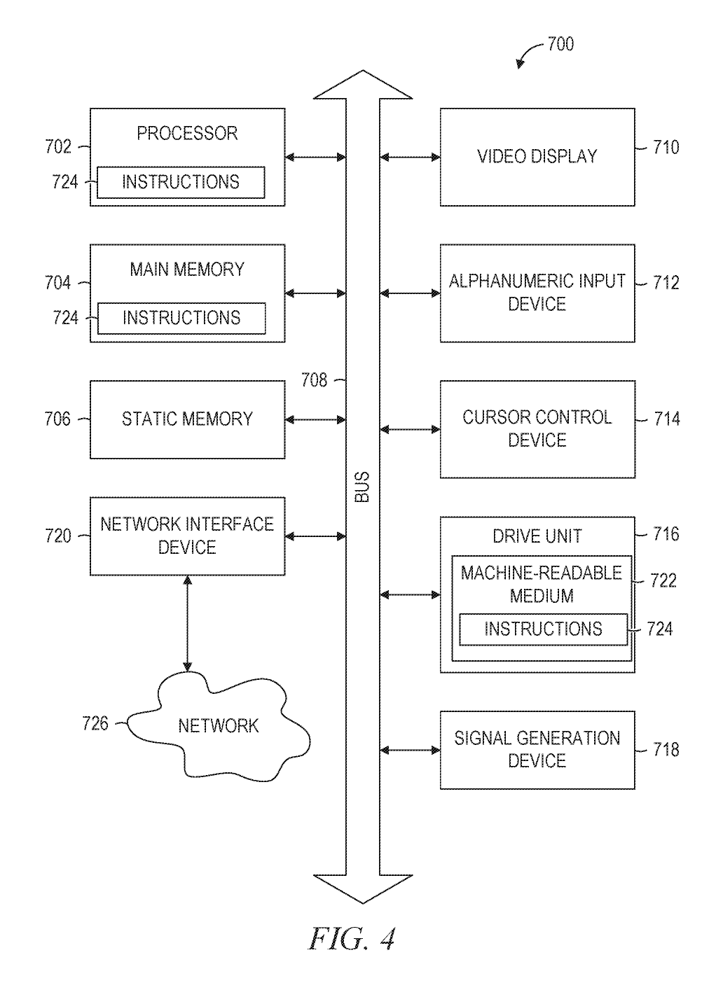

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (SIB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information)

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least sonic of the operations may be performed by a group of computers (as examples of machines including processors), these operations being accessible via a network (e.g., the Internet) and via one or more appropriate interfaces (e.g., Application Program Interfaces (APIs).)

Thus, method and system to estimate personalized engagement probability for an update in an on-line social network have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
collecting in real time engagement signals with respect to a focus update in an on-line social network system, an engagement signal represents a positive engagement with the update or an absence of engagement with the update by a member from the focus members, the focus members are those members in the on-line social network system to whom the update has been presented, the focus members represented by respective member profiles each including one or more features from a set of features, the focus update is an information item for presentation to one or more members represented by respective member profiles in the on-line social network system;
calculating, using at least one processor, in real time, for the focus update and the set of features, respective probabilities of positive engagement with the focus update by a member represented by a profile that includes a feature from the set of features, based on the collected engagement signals; and
including the calculated respective probabilities as training data for training a final pass ranker, the final pass ranker to generate a rank for each item in an inventory of updates based on features associated with a member profile in the on-line social network system.

2. The method of claim 1, comprising selecting one or more items from the inventory for including them in a news feed of the member represented by the member profile, based on the respective ranks generated by the final pass ranker for each item in the inventory of updates.

3. The method of claim 2, comprising constructing a news feed web page that includes the one or more items from the inventory.

4. The method of claim 3, comprising causing presentation of the news feed web page on a display device of the member.

5. The method of claim 1, comprising calculating, for the focus update and one or more features from the set of features, a probability of positive engagement with the focus update by a member represented by a profile that includes the one or more features.

6. The method of claim 5, comprising utilizing the calculated probability of positive engagement with the focus update by a member represented by a profile that includes the one or more features as training data for training the final pass ranker.

7. The method of claim 5, wherein the calculating, for the focus update and the one or more features from the set of features, the probability of positive engagement with the focus update by a member represented by a profile that includes the one or more features comprises utilizing a logistic regression model.

8. The method of claim 5, wherein the calculating, for the focus update and the one or more features from the set of features, the probability of positive engagement with the focus update by a member represented by a profile that includes the one or more features comprises utilizing a Naive Bayes model.

9. The method of claim 1, wherein the focus update is a job posting or a news article.

10. The method of claim 1, wherein a feature in the set of features represents an item selected from a group comprising an industry, a company, a geographic location, and a skill.

11. A computer-implemented system comprising:
an engagement signals collector, implemented using at least one processor, to collect engagement signals with respect to a focus update in an on-line social network system, an engagement signal represents a positive engagement with the update or an absence of engagement with the update by a member from the focus members, the focus members are those members in the on-line social network system to whom the update has been presented, the focus members represented by respective member profiles each including one or more features from a set of features, the focus update is an information item for presentation to one or more members represented by respective member profiles in the on-line social network system;
a personalized engagement probability calculator, implemented using at least one processor, to calculate, in real time, for the focus update and the set of features, respective probabilities of positive engagement with the focus update by a member represented by a profile that includes a feature from the set of features, based on the collected engagement signals; and
a training module, implemented using at least one processor, to include the calculated respective probabilities as training data for training a final pass ranker, the final pass ranker to generate a rank for each item in an inventory of updates based on features associated with a member profile in the on-line social network system.

12. The system of claim 11, comprising a selector, implemented using at least one processor, to select one or more items from the inventory for including them in a news teed of the member represented by the member profile, based on the respective ranks generated by the final pass ranker for each item in the inventory of updates.

13. The system of claim 12, comprising a web page generator, implemented using at least one processor, to construct a news feed web page that includes the one or more items from the inventory.

14. The system of claim 13, comprising a presentation module, implemented using at least one processor, to cause presentation of the news feed web page on a display device of the member.

15. The system of claim 11, wherein the personalized engagement probability calculator is to calculate, for the focus update and one or more features from the set of features, a probability of positive engagement with the focus update by a member represented by a profile that includes the one or more features.

16. The system of claim 15, wherein the training module is to include the calculated probability of positive engagement with the focus update by a member represented by a profile that includes the one or more features as training data for training the final pass ranker.

17. The system of claim 15, wherein the personalized engagement probability calculator is to calculate, for the focus update and the one or more features from the set of features, the probability of positive engagement with the focus update by a member represented by a profile that includes the one or more features comprises utilizing a logistic regression model.

18. The system of claim 15, wherein the personalized engagement probability calculator is to calculate, for the focus update and the one or more features from the set of features, the probability of positive engagement with the focus update by a member represented by a profile that includes the one or more features comprises utilizing a Naive Bayes model.

19. The system of claim 11, wherein the focus update is a job posting or a news article.

20. A machine-readable non-transitory storage medium having instruction data executable by a machine to cause the machine to perform operations comprising:
collecting in real time engagement signals with respect to a focus update in an on-line social network system, an engagement signal represents a positive engagement with the update or an absence of engagement with the update by a member from the focus members, the focus members are those members in the on-line social network system to whom the update has been presented, the focus members represented by respective member profiles each including one or more features from a set of features, the focus update is an information item for presentation to one or more members represented by respective member profiles in the on-line social network system;
calculating, in real time, for the focus update and the set of features, respective probabilities of positive engagement with the focus update by a member represented by a profile that includes a feature from the set of features, based on the collected engagement signals; and
including the calculated respective probabilities as training data for training a final pass ranker, the final pass ranker to generate a rank for each item in an inventory of updates based on features associated with a member profile in the on-line social network system.
